(19) United States
(12) Patent Application Publication
(10) Pub. No.: US 2008/0257925 A1
(43) Pub. Date: Oct. 23, 2008

(54) Ski rack with horizontal storage

(76) Inventor: Wesley Brooks, Gilbert, AZ (US)

Correspondence Address: Gene R. Woodle, 3516 Woodle Drive, Rapid City, SD, 57702, US

(21) Appl. No.: 11/789,362

(22) Filed: Apr. 23, 2007

(51) Int. Cl. B60R 9/00

(52) U.S. Cl. 224/315

(57) ABSTRACT

A ski rack with horizontal storage is disclosed which may be removably affixed to a conventional trailer hitch on a vehicle. The ski rack includes a base which is parallel to the rear bumper of the vehicle. The base includes a pair of hinges. A rear carrier is rotatably affixed to the hinges and rotates downward and rearward. A front carrier is complimentary to the rear carrier, but remains substantially vertical Skis or snow boards may be secured between the rear carrier and the front carrier.

### BACKGROUND OF THE INVENTION

1. Field of the Invention

The present invention relates generally to ski racks and more specifically to a ski rack with horizontal storage which may be removably affixed to the trailer hitch of a vehicle.

2. Background Information

Millions of people around the world enjoy winter sports and carry skis, snow boards, and similar articles with their vehicles. Most of these people find it most convenient to carry such items attached outside the vehicle. A number of racks or carriers have been invented which are removably affixed to the rear or top of a vehicle and may be used to carry items such as skis or snow boards on the rack or carrier.

On of the earlier of such carriers is an automobile carrier for lengthy articles disclosed in the patent to Hendrick (U.S. Pat. No. 2,106,503; Feb. 6, 1937). This device includes a frame which may be attached to the rear bumper and outside spare tire of a vehicle. The frame includes a plurality of slots into which skis may be placed vertically and a hinged cross bar which may be locked to secure the skis within the frame. The patent to Hehr (U.S. Pat. No. 6,401,999; Jun. 11, 2002) discloses a ski rack which may be removably affixed to an existing trailer hitch on a vehicle. This rack includes a plurality of top and bottom bars which protrude horizontally away from the rear of the vehicle. Skis may be secured vertically in pairs between pairs of top and bottom bars.

The ski rack with horizontal storage of the instant invention solves a number of problems common to ski or snow board racks: it is designed such that the rack may be removably affixed to a trailer hitch on a vehicle, skis and snow boards may be secured within the rack horizontally, and multiple skis and snow boards may be secured at the same time without the need to secure each ski and snow board individually.

The ideal ski rack with horizontal storage should be designed such that it may be removably attached to the trailer hitch of a vehicle. The ideal ski rack with horizontal storage store skis or snow boards horizontally. The ideal ski rack with horizontal storage should also provide for securing many skis or snow boards at the same time without the need to secure each ski or snow board individually. The ideal ski rack with horizontal storage should also be simple, reliable, inexpensive, and easy and safe to use.

### SUMMARY OF THE INVENTION

The ski rack with horizontal storage of the instant invention includes a substantially horizontal base which is parallel to the rear of the vehicle and includes a hitch member which is perpendicular to the base. The hitch member may be removably affixed to the trailer hitch receiver of a vehicle in a conventional manner. A pair of hinges are affixed to the top of the base near the ends of the base. A rear carrier which has the general shape of a square “C” which opens downward is rotatably affixed to the hinges on the base. The rear carrier is capable of rotating from substantially vertical rearward and downward.

A second carrier, a front carrier, is also affixed to the hinges and is between the rear carrier and the rear of the vehicle. The front carrier does not rotate, but remains in a substantially vertical position. A pair of rear carrier fasteners are affixed to the top of the rear carrier and a complimentary pair of front carrier fasteners are affixed to the top of the front carrier.

In operation, the rear carrier may be rotated rearward until the rear carrier is pulled slightly away from the front carrier. A plurality of skis or snow boards may be loaded horizontally between the rear and front carrier. The rear carrier is then rotated upward and forward until the skis or snow boards are secured between the rear carrier and the front carrier. The top of the rear carrier may be secured to the front carrier by means of, for example, a padlock securing a rear carrier fastener to the complementary front carrier fastener. The skis or snow boards may be removed by reversing the operation.

The above describes the basic operating principals and configuration of the ski rack with horizontal storage of the instant invention in one embodiment, but the instant invention could be used to carry items other than skis or snow boards with minimal alteration.

One of the major objects of the present invention is to provide a ski rack which may be removably attached to the trailer hitch of a vehicle.

Another objective of the present invention is to provide a ski rack which may be used to store skis or snow boards horizontally.

Another objective of the present invention is also to provide a ski rack with which many skis or snow boards may be secured at the same time without the need to secure each ski or snow board individually.

Another objective of the present invention is to provide a ski rack with horizontal storage which is simple, reliable, inexpensive, and easy to install, service and use.

These and other features of the invention will become apparent when taken in consideration with the following detailed description and the drawings.

### BRIEF DESCRIPTION OF THE DRAWINGS

FIG. 1 is a rear view of the ski rack with horizontal storage of the instant invention;

FIG. 2 is a sectional view of the ski rack with horizontal storage of the instant invention taken along line 2-2 of FIG. 1;

FIG. 3 is a detail view of the top portion of FIG. 2; and

FIG. 4 is a detail view of the bottom portion of FIG. 2.

### DESCRIPTION OF A PREFERRED EMBODIMENT

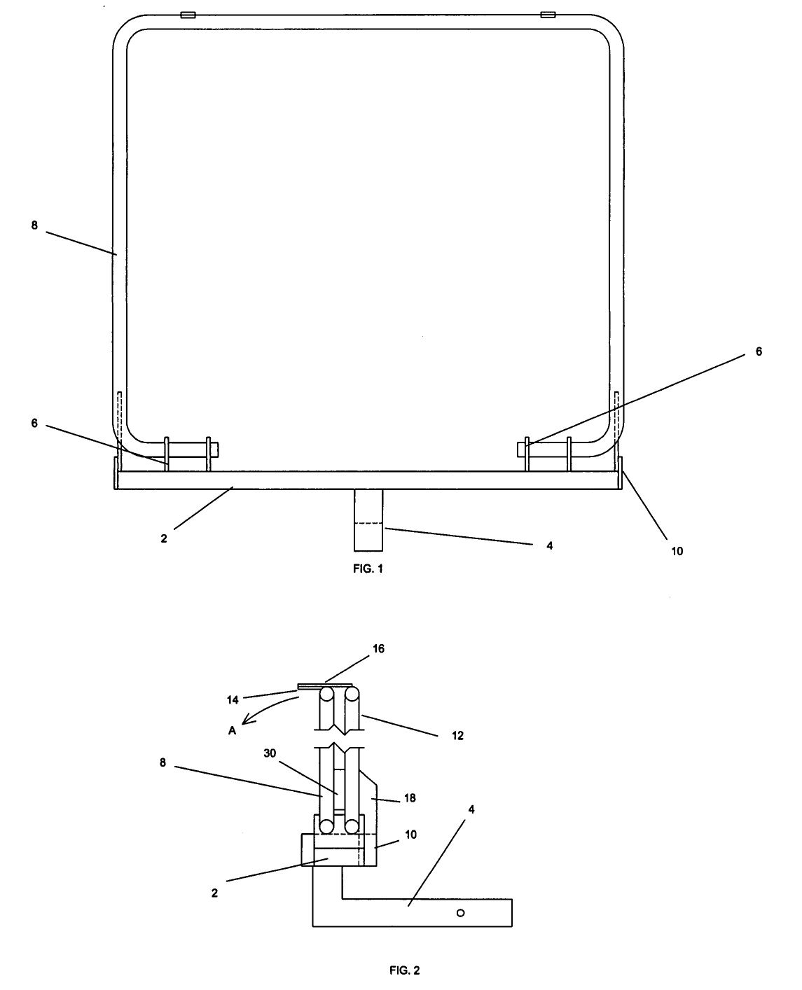

Referring to the drawings, FIGS. 1 through 4, there is shown a preferred embodiment of the ski rack with horizontal storage of the instant invention. The instant invention is shown and described as being used to carry skis or snow board, but could be used for other, similar articles. The ski rack with horizontal storage is made to be used with a vehicle which has a conventional trailer hitch receiver. The front of the vehicle is considered to be forward and the rear of the vehicle is considered to be rearward. The vehicle is not shown.

Now referring to FIG. 1, rear view of the ski rack with horizontal storage of the instant invention is shown. A base 2, having a rectangular cross section, is affixed to a hitch member 4 which protrudes perpendicularly forward from the bottom of the base 2. The length of said base 2 is slightly less than the length of the flat portion of a conventional snow board. The hitch member 4 may be removably affixed to a conventional trailer hitch receiver on a vehicle. This places said base 4 parallel with the rear bumper of the vehicle. A pair of hinges 6 are affixed to said base 4 with one of the hinges 6 near both ends of said base 4. A rear carrier 8, which has the general shape of a square “C” which opens downward, is inserted into said hinges 6 by spreading the sides of the rear carrier 8 until the two ends of the “C” shape may be inserted into holes (not shown in this view) in said hinges 6. Said rear carrier 8 is rotatable within said hinges 6 and may be moved from a position which is substantially vertical in a direction which is rearward and downward. The width of said carrier 8 is slightly less than the length of the flat portion of a conventional snow board. A pair of plates 10 are affixed to the ends of said base 2 and protrude toward the vehicle. Each of said hinges 6 include two rectangular plates with two holes through each of the plates.

Referring now to FIG. 2, a sectional view of the ski rack with horizontal storage of the instant invention taken along line 2-2 of FIG. 1 is shown. This view better shows the configuration of said hitch member 4 and said base 2. A front carrier 12 having substantially the same size and shape as said rear carrier 8 is also affixed to said hinges 6, but is fixed and remains substantially vertical. A rear carrier fastener 14 protrudes rearward from the top of said rear carrier 8 and a complementary front carrier fastener 16 protrudes rearward from the top of the front carrier 12. Said front carrier 12 is inserted into holes in said hinges 6 in the same manner as said rear carrier 8. A brace 18 is affixed to the forward portion of each of the plates 10 and protrudes upward from said plates 10. The braces 18 abut the forward surface of the bottom of said front carrier 12 and are affixed to said front carrier 12 to hold it in place. Arrow A shows the direction of rotation of said rear carrier 8.

Still referring to FIG. 2, said rear carrier 8 may be rotated in the direction of arrow A and a ski 20 (not a part of the invention) placed between said rear carrier 8 and said front carrier 12 near said base 2. Said rear carrier 8 may then be rotated in the opposite direction which secures the ski 20 between said rear carrier 8 and said front carrier 12. Of course, a plurality of skis or snow boards could be secured in the same fashion. In a second embodiment, foam or a similar padding material would be placed on the forward surface of said rear carrier 8 and the rearward surface of said front carrier 12 to protect skis or snow boards.

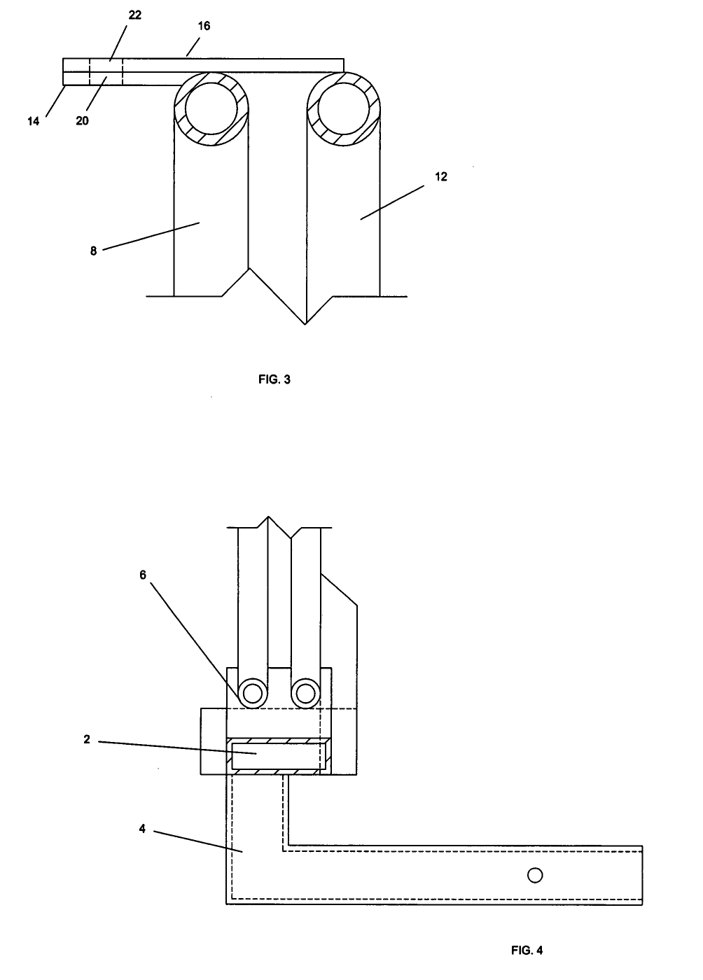

Referring now to FIG. 3, a detail view of the top portion of FIG. 2 is shown. This view better shows the relationship of said rear carrier fastener 14 to said front carrier fastener 16. There is a rear hole 20 near the rearward end of said rear carrier fastener 14 and a complementary front hole 22 near the rearward end of said front carrier 12. Using said rear carrier fastener 14 and said front carrier fastener 16, said rear carrier 8 may be temporarily secured to said front carrier 12 by placing a conventional clip or padlock through said rear hole 20 and said front hole 22.

Referring now to FIG. 4, a detail view of the bottom portion of Figure is shown. This view better shows the holes in said hinges 6. This view also better shows the relationship of said base 2 to said hitch member 4 and said plates 10.

In operation, said rear carrier 8 may be swung away from said front carrier 12 and a plurality of skis or snow boards placed between said rear carrier 8 and said front carrier 12. Said rear carrier 8 may then be swung back up to said front carrier 12 until said rear hole 20 is aligned with said front hole 22. Said rear carrier 8 may be temporarily secured to said front carrier 12 using a conventional clip or padlock.

All elements of the ski rack with horizontal storage are made of steel, but other materials having similar strength, weather resistance, and weight could be used.

While preferred embodiments of this invention have been shown and described above, it will be apparent to those skilled in the art that various modifications may be made in these embodiments without departing from the spirit of the present invention.

I claim:

1. A ski rack which is configured to be removably affixed to a conventional trailer hitch on a vehicle in which the front of the vehicle is considered forward and the rear of the vehicle is considered rearward comprising:
(1) a base which is substantially horizontal and has a hitch member perpendicular to the base and the hitch member protrudes forward from said base and said hitch member may be removably affixed to a conventional trailer hitch receiver on a vehicle;
(2) a pair of hinge members which are affixed at either end of said base;
(3) a forward carrier member having the general shape of a square “C” with the opening downward, the forward carrier member being affixed substantially vertically at the top, forward surface of said base;
(4) a rearward carrier member having the general shape of a square “C” with the opening downward, the rearward carrier member being rotatably affixed at its bottom to the hinge members such that said rearward carrier member may rotate from a substantially vertical position rearward and downward and, when said rearward carrier member is substantially vertical, said rearward carrier member is rearward of said forward carrier member and less than the width of a conventional ski or snow board from said forward carrier member; and
(5) fastening means affixed to said forward carrier member and said rearward carrier member such that, when said forward carrier member and said rearward carrier member are substantially vertical they may be fastened together using the fastening means;
whereby said rearward carrier member may be rotated rearward and downward, skis or snow boards may be placed horizontally between said rearward carrier member and said forward carrier member, said rearward carrier member may be rotated back to a substantially vertical position, and said rearward carrier member fastened to said forward carrier member such that the skis or snow boards are held in place.

2. The ski rack of claim 1 in which said fastening means may be locked.

3. The ski rack of claim 1 in which padding material is affixed to the rearward surface of said forward carrier member and to the forward surface of said rearward carrier member.

4. The ski rack of claim 2 in which padding material is affixed to the rearward surface of said forward carrier member and to the forward surface of said rearward carrier member.
